(19) United States
(12) Patent Application Publication
(10) Pub. No.: US 2020/0364970 A1
(43) Pub. Date: Nov. 19, 2020

(54) SYSTEM AND METHOD FOR OBTAINING DATA FOR THIRD PARTY SYSTEMS

(71) Applicants: Dennis Korthouwer, Amstelveen (NL); Anton Gerard Hofland, Brand-Laaben (AT)

(72) Inventors: Dennis Korthouwer, Amstelveen (NL); Anton Gerard Hofland, Brand-Laaben (AT)

(21) Appl. No.: 16/983,916

(22) Filed: Aug. 3, 2020

Related U.S. Application Data
(63) Continuation-in-part of application No. 16/572,504, filed on Sep. 16, 2019.
Application No. 16/572,504 is a continuation of application No. 16/354,153, filed on Mar. 14, 2019, now Pat. No. 10,417,858.

(51) Int. Cl. G07F 17/32

(52) U.S. Cl. CPC G07F 17/3209; G07F 17/3206; G07F 17/3258

(57) ABSTRACT

System and method for capturing data from third-party systems in a non-intrusive way and using such data for starting a process and/or analytic purposes. The system and method work with external add-on or aftermarket products working in conjunction with electronic gaming machines in particular and third-party devices in general. For example, an add-on external jackpot system may be triggered each time an underlying electronic gaming machine is played. Accordingly, the system and method employ microdots, receivers, and computing devices configured and positioned to alert the add-on external jackpot system of each play of the underlying gaming machine. Micro optical fibers integrated into a film along with a charge coupled device may also be used. The system and method are non-intrusive.

### CROSS-REFERENCE

This application is a continuation-in-part of, and claims priority to, U.S. patent application Ser. No. 16/572,504 filed Sep. 16, 2019, which is a continuation of, and claims priority to, U.S. patent application Ser. No. 16/354,153 filed Mar. 14, 2019, now U.S. Pat. No. 10,417,858, all of which are incorporated herein by reference for all purposes.

### FIELD OF THE INVENTION

The embodiments of the present invention relate to a system and method for capturing an input signal at a gaming machine, or other type of machine, through a non-intrusive and/or add-on mechanism.

### BACKGROUND

Certain gaming machines may utilize add-on promotional and/or side bet jackpot systems. These systems are linked to the gaming machines post manufacturing of the same. As such, the systems require an input signal or trigger to activate. Fully integrating the systems into the already-manufactured gaming machine requires the cooperation of the gaming machine manufacturer, is labor intensive and cost prohibitive.

Thus, it would be advantageous to develop a non-intrusive and/or add-on mechanism capable of capturing an input signal at a gaming machine. The non-intrusive and/or add-on mechanism should be simple to install and operate.

### SUMMARY

The embodiments of the present invention are configured to operate with various user interfaces, including push buttons, handles and touchscreens, associated with electronic gaming machines. No matter the user interface, the system and method detailed herein capture an input signal corresponding to a start of a game, height of a bet and/or related activity. This is important for aftermarket products working in conjunction with electronic gaming machines. For example, the embodiments of the present invention allow a system as described in U.S. Pat. No. 9,997,020 entitled “Local Jackpot System Appearing Global in Nature and Global Prize Management System and Method of Use” (“Global Patent”) to be efficiently added to existing installed gaming machines with no intrusion of the gaming machine. U.S. Pat. No. 9,997,020 is incorporated herein by reference for any and all purposes.

For gaming machines using push buttons or handles (or other mechanical devices) a microdot chip (also referred to as a microdot herein) and receiver combination communicate with one another. Based on an applied force, the microdot communicates with the receiver to alert the third-party system that the activity (e.g., game start) has been triggered so that the third-party system may undertake its task.

For gaming machines having light emitting displays, a microdot grid is positioned on the display and is configured to communicate with a receiver to alert the third-party system that the activity (e.g., game start) has been triggered so that the third-party system may undertake its task.

In another embodiment, a film with integrated micro optical fibers directs light outputs from a display, to which the film is connected, to a charge coupled device. A computing device then analyzes the outputs of the charge coupled device to reconstitute the image from the display. A calibration and descrambling process are also utilized. In this manner, the system may alert a third-party system that the activity (e.g., video game start) has been triggered so that the third-party system may undertake its task.

Other variations, embodiments and features of the present invention will become evident from the following detailed description, drawings and claims.

### BRIEF DESCRIPTION OF THE DRAWINGS

FIGS. 1A through 1C illustrate gaming machines of the type which may be utilized with the embodiments of the present invention;

FIG. 2 illustrates a basic gaming machine network;

FIG. 3 illustrates a process for installing a microdot on a button interface of a gaming machine according to the embodiments of the present invention;

FIG. 4 illustrates a diagram showing microdots communicating with receivers according to the embodiments of the present invention;

FIG. 5 illustrates a first exemplary wiring arrangement for a light emitting display with a microgrid film according to the embodiments of the present invention;

FIG. 6 illustrates a second exemplary wiring arrangement for a light emitting display with a microgrid film according to the embodiments of the present invention;

FIG. 7 illustrates a flow chart detailing operation of a light emitting display with a microgrid film embodiment according to the embodiments of the present invention;

FIG. 8 illustrates a flow chart detailing installation of push button on a gaming machine according to the embodiments of the present invention;

FIG. 9 illustrates a diagram of gaming machine network utilizing the jackpot system according to the embodiments of the present invention;

FIG. 10 illustrates a first diagram of an alternative embodiment of the passive system for reading a display according to the embodiments of the present invention;

FIG. 11 illustrates a second diagram of an alternative embodiment of the passive system for reading a display according to the embodiments of the present invention; and

FIG. 12 illustrates a flow chart detailing a calibration and descrambling process according to the embodiments of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

Those skilled in the art will recognize that the embodiments of the present invention involve both hardware and software elements which portions are described below in such detail required to construct and operate a gaming machine method and system according to the embodiments of the present invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.), or an embodiment combining software and hardware. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), and optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied thereon, for example, in baseband or as part of a carrier wave. Such a propagated signal may take any variety of forms, including, but not limited to, electromagnetic, optical, or any suitable combination thereof. A computer readable signal medium may be any computer readable medium that is not a computer readable storage medium and that can communicate, propagate, or transport a program for use by or in conjunction with an instruction execution system, apparatus, or device.

Program code embodied on a computer readable medium may be transmitted using any appropriate medium, including but not limited to wireless, wireline, optical fiber cable, RF and the like, or any suitable combination of the foregoing.

Computer program code for carrying out operations for aspects of the present invention may be written in any combination of one or more programming languages, including an object-oriented programming language such as Java, Smalltalk, C++ or the like or conventional procedural programming languages, such as the “C” programming language, AJAX, PHP, HTML, XHTML, Ruby, CSS or similar programming languages. The programming code may be configured in an application, an operating system, as part of a system firmware, or any suitable combination thereof. The programming code may execute entirely on the user's computer, partly on the user's computer, as a standalone software package, partly on the user's computer and partly on a remote computer or entirely on a remote computer or server as in a client/server relationship sometimes known as cloud computing. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagrams.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagrams. As used herein, a “gaming device” or “gaming machine” should be understood to be any one of a general purpose computer, as for example a personal computer or a laptop computer, a client computer configured for interaction with a server, a special purpose computer such as a server, or a smart phone, soft phone, tablet computer, personal digital assistant or any other machine adapted for executing programmable instructions in accordance with the description thereof set forth above.

While gaming machines are detailed below, those skilled in the art will recognize that other types of machines may benefit from the embodiments of the present invention. The system and method may also facilitate non-intrusive software testing, influence primary process, commence a secondary process and data analysis.

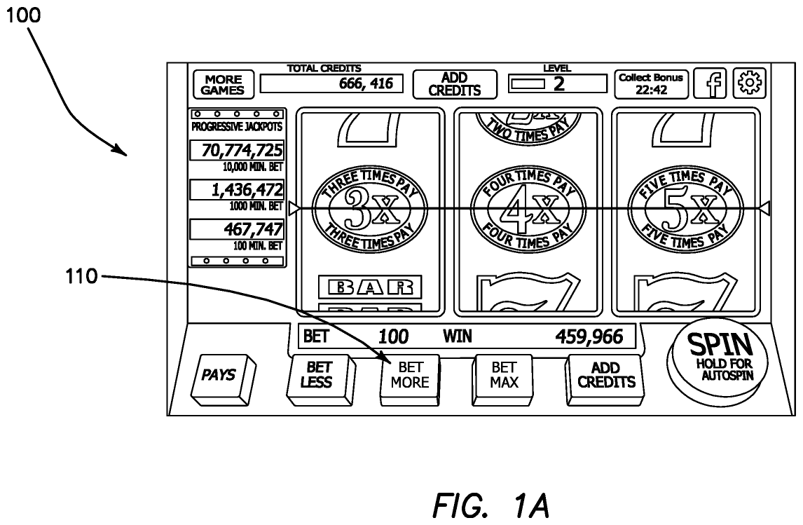

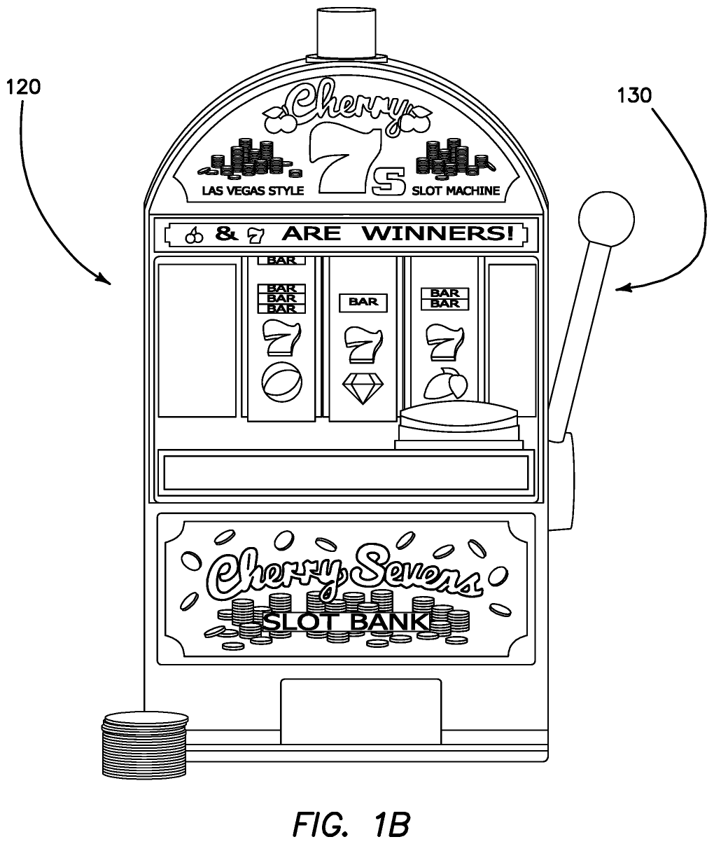

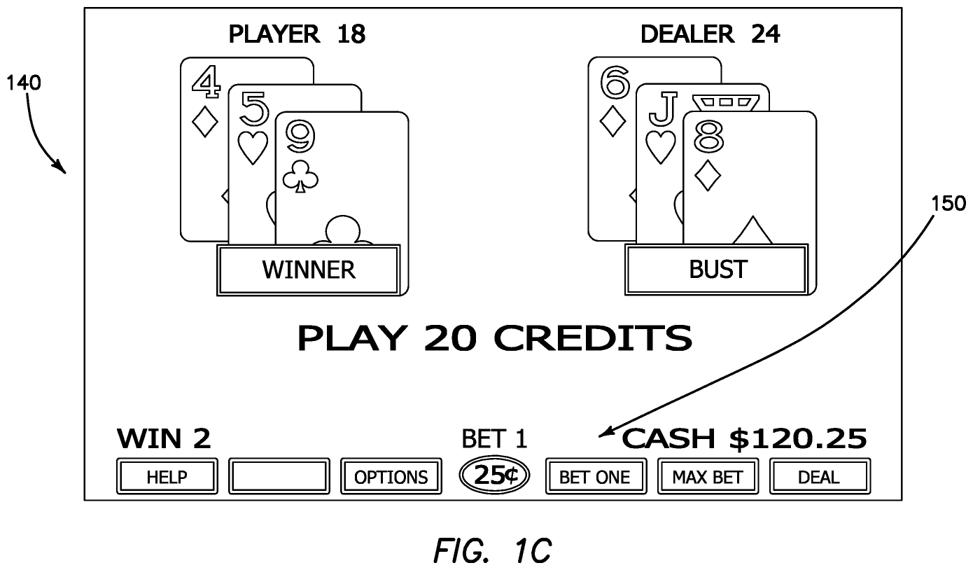

FIGS. 1A through 1C show various gaming machine types which may utilize the embodiments of the present invention. FIG. 1A shows a conventional slot machine 100 having a button panel 110 acting as a user interface; FIG. 1B shows a conventional slot machine 120 having a slot handle 130 acting as a user interface; and FIG. 1C shows a conventional video gaming machine 140 having a light emitting display 150 acting as a user interface. While gaming machines 100, 120 and 140 are shown, those skilled in the art will recognize that any type of electronic gaming machine may utilize the embodiments of the present invention.

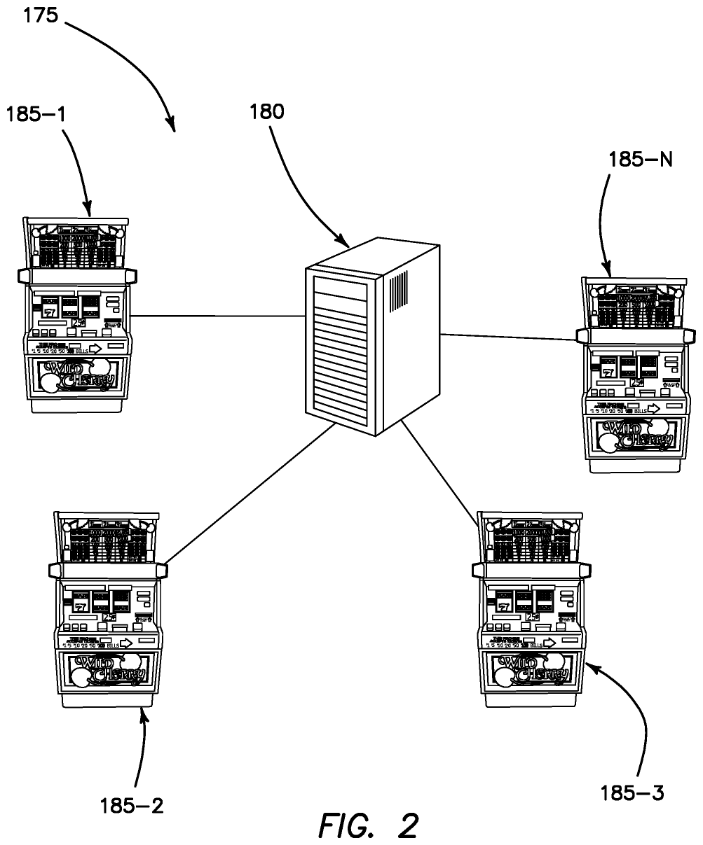

FIG. 2 shows a block diagram of a gaming network 175 which may utilize the embodiments of the present invention. The gaming network 175 comprises a central computer 180 (e.g., processor-equipped game server) in communication with multiple gaming machines 185-1 through 185-N.

The embodiments of the present invention shall be described relative to the jackpot system detailed in the Global Patent. Those skilled in the art will recognize that the embodiments of the present invention are suitable for any third-party or external systems needing to communicate with gaming machines.

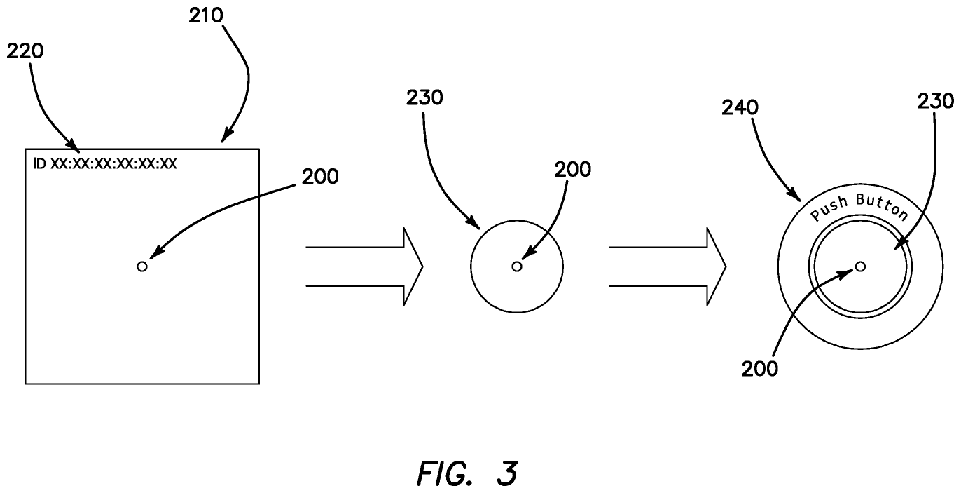

FIG. 3 shows a process for creating and installing a microdot on a button interface of a gaming machine according to the embodiments of the present invention. A microdot 200 is integrated onto a film 210. In one embodiment, the film 210 is a piece of thin, transparent film material with a sticky back allowing it to be applied to a push button or attached to a slot machine handle. The transparent film material may be cut to size to fit the application. The transparent film material has an energy harvesting capability used to power up the microdot 200 located at the center of the transparent film material as shown in FIG. 3. The microdot 200 has a unique identifier 220 displayed at the edge of the uncut film material 210.

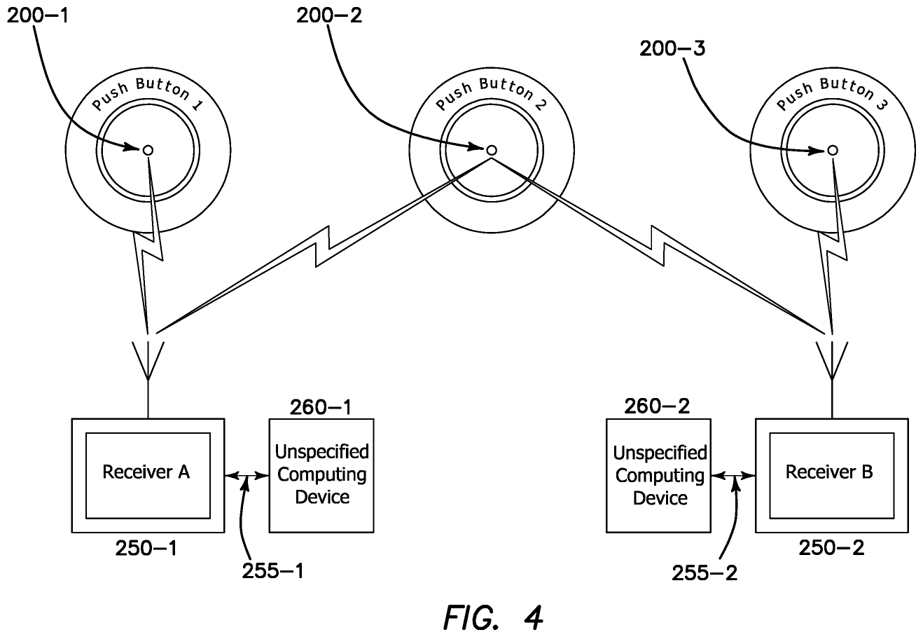

As shown in FIG. 3, the thin, transparent film material 210 is cut into a shape 230 consistent with the subject gaming machine button 240. In this manner, the thin, transparent film 210 may be adhered to the gaming machine button 240. When powering up, the microdots 200-1 through 200-3 transmit their identifiers and a reading of the amount of energy harvested to paired receivers 250-1 through 250-2 as shown in FIG. 4. The amount of energy harvested is an indication of how strongly the button 240-1 through 240-3 has been pushed or with how much force the handle has been pulled. The receivers 250-1 and 250-2 are communicatively linked 255-1 and 255-2 to the jackpot system 260-1 and 260-2.

The receivers comprise one or more of the following properties. The receivers may pair with a microdot device while in a pairing mode. Once the receivers are in the pairing mode, the microdot device to be paired is then activated several times in succession, after which the receiver(s) is paired with the microdot device. Any transmissions it receives which do not originate from a paired device, are ignored. The receivers may also tune/calibrate the microdot device. The calibration allows for different sizes of transparent film devices, and thus different levels of energy harvesting due to the size variations and allows for reliably measuring the force with which a button has been pressed or by which a handle has been pulled. To calibrate an installed microdot device, it needs to be pressed with a known force or, in case of a handle, pulled with a known force. The amount of energy generated is then used to calculate an adjustment parameter within the receiver.

The receivers 250-1 through 250-2 which receive the readings from the one or more paired microdot devices. The receiver receives its power from the computing device. Through an interface, for instance, but not limited to, USB or SPI, the receiver communicates with the computing device and may, depending on the embodiment: (a) be put in pairing mode by the computing device; (b) transmit identifier and force level to the computing device every time it receives a reading from one of its paired microdot devices; and/or (c) be put in force calibration mode for a certain paired device, the identifier of which is provided by the computing device. Once in the force calibration mode, the operator shall apply a known force to the push button or handle of the gaming machine and the microdot device transmits its identifier and the generated power reading to the receiver. Upon receipt of this identifier and reading, the receiver determines a correction parameter and reports the known force value to the computing device which is saved for this specific device. The receivers may be further configured to (a) delete from its list of paired devices a specific device, the identifier of which is provided by the computing device; (b) add to its list of paired devices a specific device, the identifier of which is provided by the computing device, together with a correction parameter, also supplied by the computing device; and (c) produce a list of identifiers of paired devices and associated correction parameters.

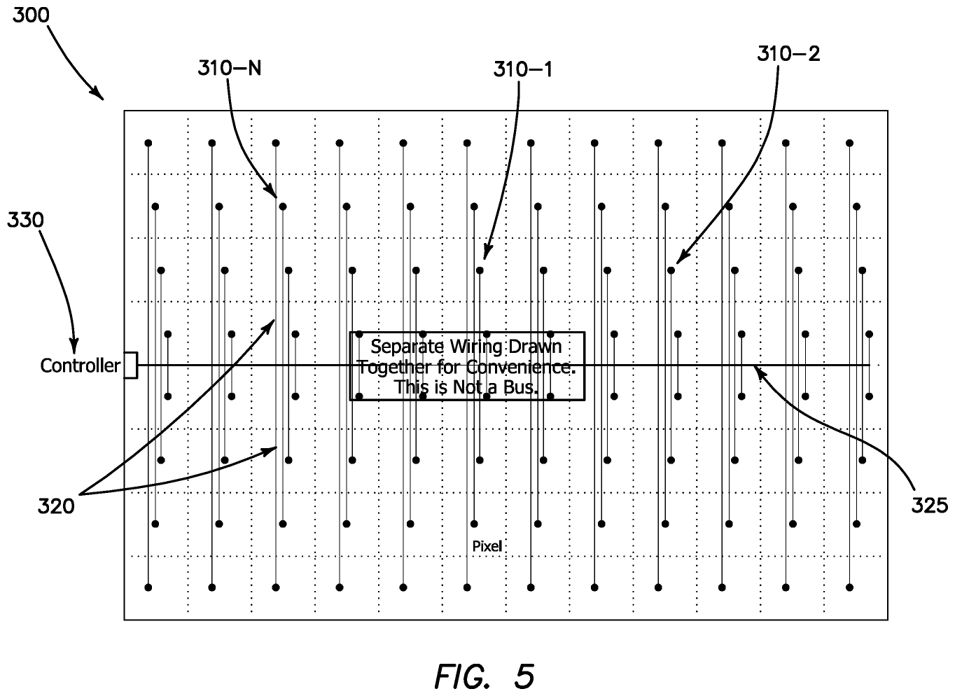

FIG. 5 refers to an embodiment of the present invention associated with gaming machines having light emitting displays (e.g., touchscreens). In such an embodiment, like the button and handle embodiments described above, the system and method are non-intrusive to the gaming machine. In this embodiment, a thin film 300 having a grid pattern of integral, light-sensitive microdots 310-1 through 310-N (i.e., microgrid film) is applied to the light emitting display. If the light emitting display incorporates touch screen technology, any touch sensitivity is retained by the microgrid film. In one embodiment, the grid pattern coincides with the resolution of the touchscreen onto which it is applied. The microdots 310-1 through 310-N are configured to sample or read the light output from the (touch)screen onto which the thin film 300 is applied. The microdots 310 only sample light levels underneath the thin film 300 whereby ambient light does not impact the readings. Based on the readings, a form of color coordinates may be created.

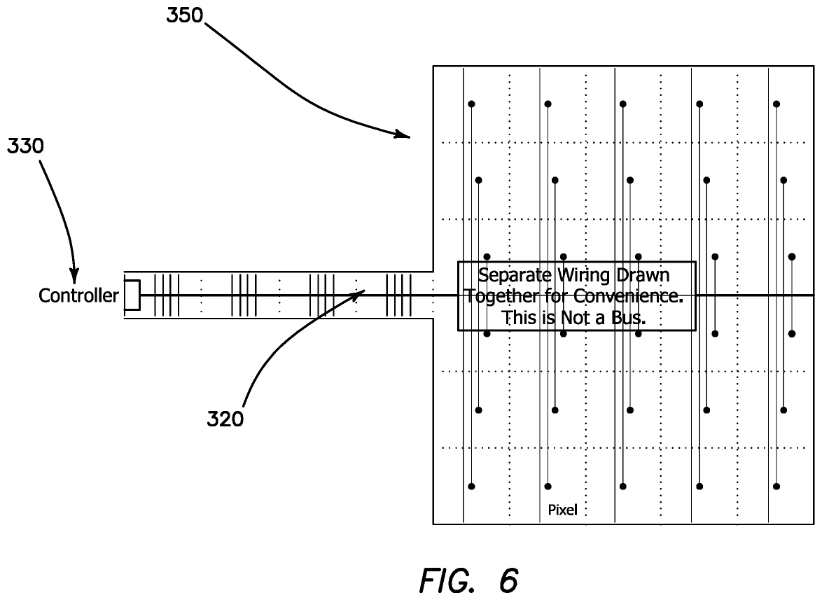

As shown in FIG. 5, the thin film 300 may be dimensioned to cover the entire (touch)screen to which it is applied. FIG. 6 shows an alternative thin film 350 dimensioned to cover only a portion of the (touch)screen to which it is applied but is otherwise operationally the same as thin film 300. In either embodiment, the microdots 310-1 through 310-N communicate via a wired arrangement 320 with a controller 330. The wiring arrangement 320 permits the controller 330 to determine the location of each microdot 310-1 through 310-N via its wire connection with the controller 330.

The use of the wired arrangement 320 permits the easy cutting of the thin film 300 to create the thin film 350 shown in FIG. 6. Since each microdot 310-1 through 310-N is wired to primary wire 325, the thin film 300 can be cut into any configuration as long as primary wire 325, leading to the controller 330, is not severed. While not shown, the controller 330 has an interface (e.g., USB) for communicating with the computing device. The computing device also supplies the controller 330 and microdots 310-1 through 310-N with power.

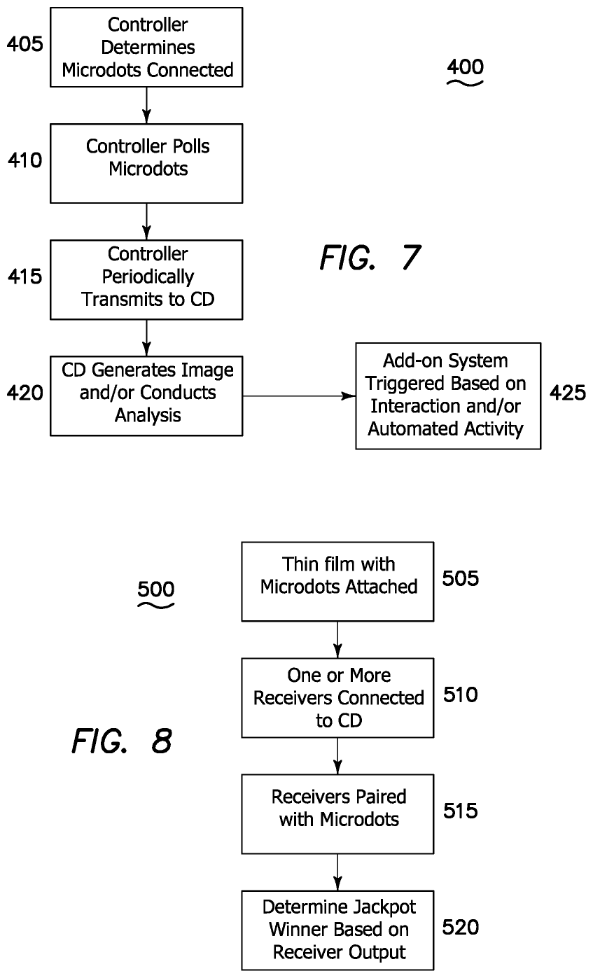

Now referring to the flowchart 400 in FIG. 7, upon power up, at 405, the controller 330 first determines which microdots 310-1 through 310-N are connected. Based on cutting the thin film 300 for the subject light emitting display, many of the microdots 310-1 through 310-N may not exist on the thin, film 300 (i.e., were removed when thin film 300 cut). At 410, the controller polls the connected microdots 310-1 through 310-N. The polling period may be determined by the controller 330. At 415, the controller 330 periodically transmits to the computing device the location of each microdot 310-1 through 310-N and their readings. At 420, the computing device uses the received data to generate an image of the light emitting display or part thereof to which the thin film is attached or conducts analysis using the data. The period of transmissions may be determined by the controller 330. The captured data and/or image may be used for analysis purposes. At 425, responsive to the screen image changes captured, the add-on or external system may be triggered.

FIG. 8 shows a flow chart 500 detailing a methodology for utilizing the embodiments of the present invention with the system described in the Global Patent. At 505, the subject gaming machines (e.g., slot machines) are subjected to the add-on process whereby the thin film with microdots is configured for attachment to an interface (e.g., push button, handle or touchscreen) of the gaming machine. Multiple interfaces (e.g., push button and handle) on a single gaming machine may receive the thin film and microdots. At 510, one or more receivers are connected to the computing device. At 515, the receivers are paired with the installed microdots. At 520, the computing device monitors receiver outputs and manages the jackpot software to determine if the player of the gaming machine is a jackpot winner. In this manner, the jackpot system can easily be linked to a plurality of the gaming machines without the need to open the gaming machines thereby eliminating any loss of certification and/or re-certification process for the gaming machine.

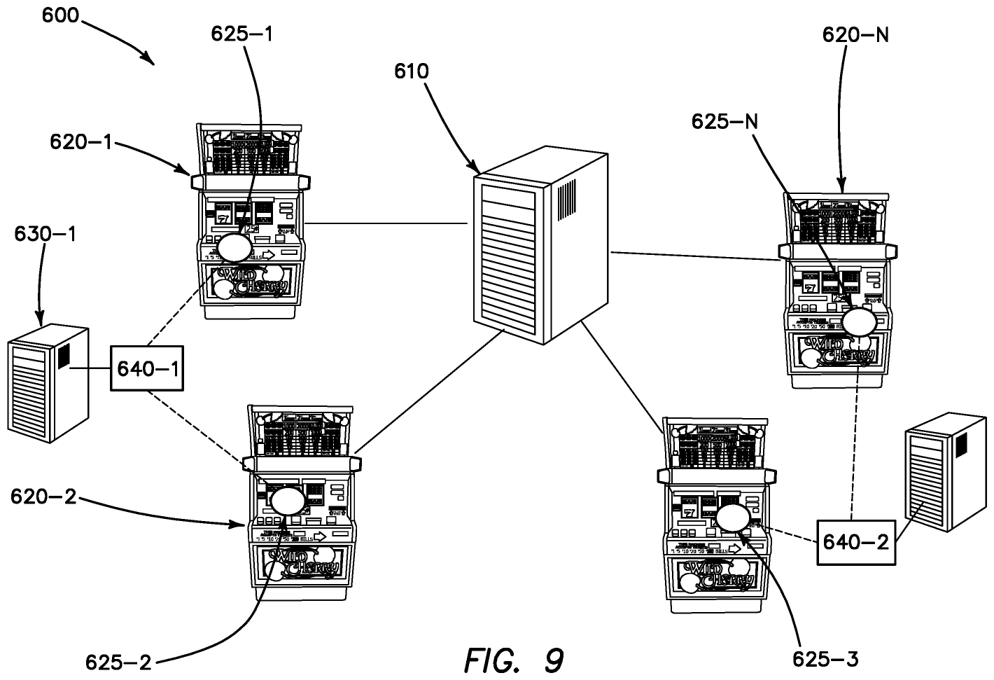

FIG. 9 shows a gaming machine network 600 utilizing the jackpot system based on the embodiments of the present invention. As shown, a central server or computer 610 provides game content, accounting functions, player tracking function, and the like for the network 600 of gaming machines 620-1 through 620-N. In this embodiment, a pair of computing devices 630-1 and 630-2 receivers and receivers 640-1 and 640-2 communicate with microdots 625 applied to each gaming machine 620-1 through 620-N.

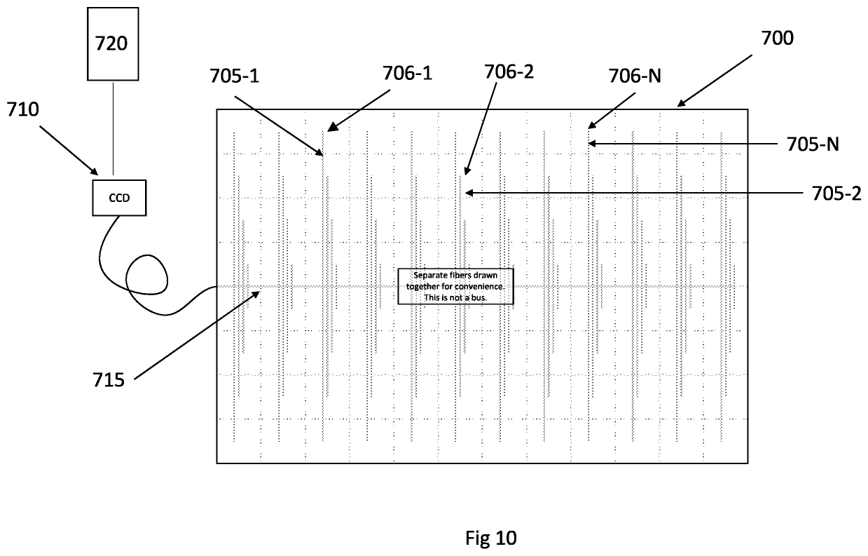

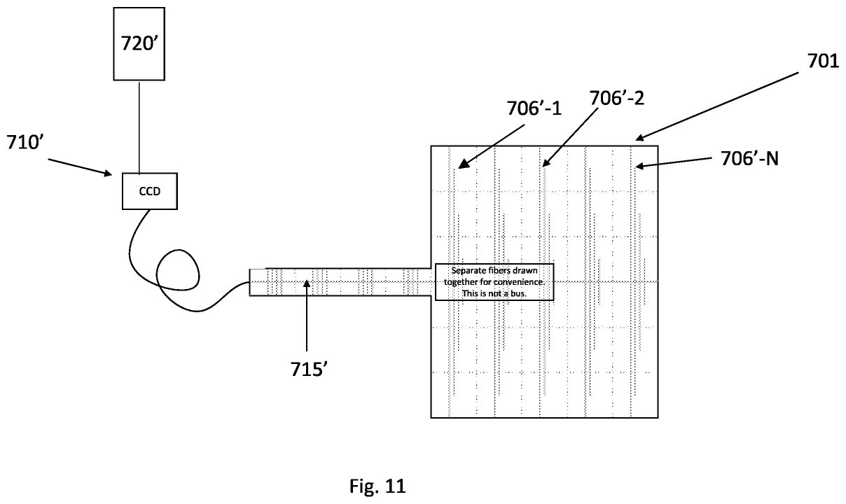

FIGS. 10 and 11 illustrate an alternative embodiment of the system for reading a display according to the embodiments of the present invention and alerting a third-party system that the activity (e.g., video game start) has been triggered so that the third-party system may undertake its task. In this embodiment, a film 700 contains a series of micro optical fibers 705-1 through 705-N configured to capture portions of light emanating from a display to which the film is attached. The film 700 is transparent so as not to interfere with the display to which it is attached and the micro optical fibers 705-1 through 705-N are minute enough to be substantially transparent as well. Once captured, the portions of light are directed to a charge coupled device (CCD) 710 via fiber cable 715 to which all of the micro optical fibers 705-1 through 705-N are connected. The fiber cable 715 may extend directly to the CCD or connect to an intermediary cable or cord before connecting to the CCD 710. As used herein a CCD is any integrated circuit containing an array of linked, or coupled, capacitors. Other devices such as CMOS Sensors may also be used in lieu of the CCD.

In one embodiment, the connection between the micro optical fibers 705-1 through 705-N and the CCD 710 is configured so that the output of each micro optical fiber 705-1 through 705-N can be sampled by exactly one pixel on the CCD 710. Pixels of the CCD 710 are represented by p-doped metal-oxide-semiconductor (MOS) capacitors. The MOS capacitors are biased above the threshold for inversion when image acquisition begins allowing the conversion of incoming photons into electron charges at the semiconductor-oxide interface whereby the CCD 710 is able to read out these charges. As detailed below, a linked computing device 720 (e.g., laptop computer) reads and analyzes the data generated by the CCD 710. The computing device 720 may connect to the CCD 710 via a conventional means including wired (e.g., USB) or wireless connections (e.g., Wi-Fi). In one embodiment, the CCD 710 is powered by the computing device 720. Alternatively, the CCD 710 may have its own dedicated power source.

In one embodiment, the CCD 710 is configured to sample in parallel the light captured by each of the angled end points 706-1 through 706-N of the micro optical fiber 705-1 through 705-N and the computing device 720 is configured to reconstitute the image from the data read (i.e., captured light).

As shown in FIG. 11, the film 701 may be cut or otherwise manipulated to adapt to the location of interest on the display. The micro optical fibers 705′-1 through 705′-N that are cut do not operate to capture light given the angled end points 706′-1 through 706′-N have been removed. The functionality of film 701 is identical to that of film 700 such that light captured from the display travels through the uncut micro optical fibers 705′-1 through 705′-N to fiber cable 715′ to the CCD 710′ which is connected to a computing device 720′.

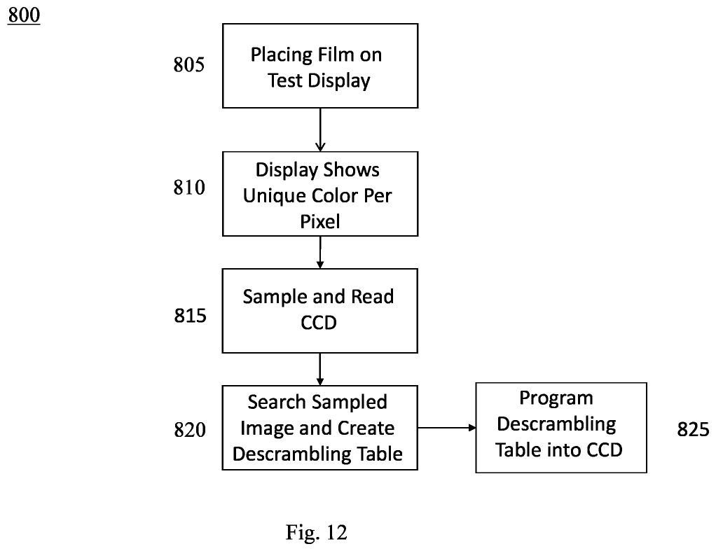

In one embodiment, the computing device 720, 720′, or a different computing device, must calibrate and descramble the output of the fiber cable 715, 715′. This is due to the random manner in which the micro optical fibers 705-1 through 705-1 or 705′-1 through 705′-N are connected causing the output to be scrambled. In one embodiment, as detailed in flow chart 800 of FIG. 12, the calibration and descrambling process comprises: (i) placing/adhering/positioning the film on a test display having the same resolution as the film 805; (ii) causing the display to show a unique color per pixel 810; (iii) utilizing a computing device to sample and read the CCD 815; whereby the computing device is configured to: (iv) search the sampled image for each of the unique colors presented by the test display and create a descrambling table 820 and (v) program the descrambling table into the CCD and applying the descrambling step each time the micro optical fibers 705-1 through 705-1 or 705′-1 through 705′-N have been sampled 825. This method is akin to a single instruction multiple data (SIMD) stream operation which is performed in micro-seconds using the appropriate hardware. The film and associated CCD are then used together according to the embodiments of the present invention as each film is substantially unique.

In an alternative embodiment, the film may be used as a stick-on display. In this embodiment, the film is applied to a surface with the angled end points of the micro optical fibers facing outward (i.e., toward an observer). The film, via the cable or other means, is attached to an array of light emitting diodes (LEDs) and computing device. As an image is forwarded to the array of LEDs by the computing device, the light captured form the array of LEDs is directed to, and exits through, the end points of the micro optical fibers to the observer. As each image is presented to the LED array by the computing device or similar device, the image needs to be scrambled in an operation opposite to that detailed above for de-scrambling but using the same de-scrambling table.

In one embodiment, invisible, augmented reality devices may be created by suitably combining two films together (i.e., one “sampling” film and one “display” film).

While the detailed description herein focuses on electronic gaming machines, those skilled in the art will recognize that add-on or external systems may be triggered by any type of electronic device capable of being retrofitted as described herein.

Although the invention has been described in detail with reference to several embodiments, additional variations and modifications exist within the scope and spirit of the invention as described and defined in the following claims.

We claim:

1. A system comprising:
a film having a series of micro optical fibers;
a charge coupled device connected to said film, said charge coupled device configured to receive light outputs from said micro optical fibers; and
a computing device configured to read said charge coupled device and, based on data read from said charge coupled device, reconstitute an image from said display.

2. The system of claim 1 wherein said series of micro optical fibers are connected to a common cable running through said film.

3. The system of claim 2 wherein said cable is adapted to connect to said charge coupled device.

4. The system of claim 1 wherein said micro optical fibers have angled end points.

5. The system of claim 3 wherein said cable is connected to said charge coupled device so that each micro optical fiber is sampled by one exactly one pixel on said charge coupled device.

6. A system comprising:
a film combined with a series of micro optical fibers having angled end points for receiving light from the display to which the film is adhered;
a charge coupled device configured to receive light outputs from said micro optical fibers; and
a computing device configured to read said charge coupled device and, based on data read from said charge coupled device, reconstitute an image from said display.

7. The system of claim 6 wherein said series of micro optical fibers are connected to a common cable running through said film.

8. The system of claim 7 wherein said cable is adapted to connect to said charge coupled device.

9. The system of claim 8 wherein said cable is connected to said charge coupled device so that each micro optical fiber is sampled by one exactly one pixel on said charge coupled device.

10. A method comprising:
(i) positioning a film on a display, said film including a series of integrated micro optical fibers;
(ii) utilizing a charge coupled device to sample light outputs from said micro optical fiber; and
(iii) utilizing a computing device to read said charge coupled device and, based on data read from said charge coupled device, reconstitute an image from said display.

11. The method of claim 10 further comprising connecting said series of integrated micro optical fibers to a common cable running through said film.

12. The method of claim 11 further comprising adapting said cable to connect to said charge coupled device.

13. The method of claim 10 wherein said micro optical fibers have angled end points.

14. The method of claim 12 further comprising connecting said cable to said charge coupled device so that each micro optical fiber is sampled by one exactly one pixel on said charge coupled device.

15. A gaming system comprising:
a film having a series of integrated micro optical fibers, said film attached to a display of an electronic gaming device;
a charge coupled device connected to said film, said charge coupled device configured to receive light outputs from said micro optical fibers;
a computing device configured to read said charge coupled device; and
wherein data read by said computing device from said charge coupled device triggers an action related to operation of said electronic gaming device.

16. The gaming system of claim 15 wherein said series of integrated micro optical fibers are connected to a common cable running through said film.

17. The gaming system of claim 16 wherein said is cable adapted to connect to said charge coupled device.

18. The gaming system of claim 15 wherein said micro optical fibers have angled end points.

19. The gaming system of claim 17 wherein said cable is connected to said charge coupled device so that each micro optical fiber is sampled by one exactly one pixel on said charge coupled device.

20. A system comprising:
a film combined with a series of micro optical fibers having angled end points;
an array of light emitting diodes connected to a computing device and said series of micro optical fibers; and
wherein said angled end points of said series of micro optical fibers are configured to emit light based on an image fed to the array of light emitting diodes by said computing device.

21. The system of claim 20 wherein said series of micro optical fibers are connected to a common cable running through said film.

22. The system of claim 20 wherein said is cable adapted to connect to said array of light emitting diodes.
